(19) United States
(12) Patent Application Publication
(10) Pub. No.: US 2025/0058407 A1
(43) Pub. Date: Feb. 20, 2025

(54) METHOD AND LASER PROCESSING SYSTEM FOR LASER WELDING

(71) Applicant: PRECITEC GMBH & CO. KG, Gaggenau (DE)

(72) Inventors: Thorsten Lorenz, Iffezheim (DE); Sebastian Moser, Rochester Hills, MI (US); Sascha Grau, Karlsruhe (DE); Markus Kogel-Hollacher, Haibach (DE); Jens Reiser, Rheinstetten (DE)

(73) Assignee: PRECITEC GMBH & CO. KG, Gaggenau (DE)

(21) Appl. No.: 18/706,603

(22) PCT Filed: Nov. 4, 2022
(86) PCT No.: PCT/EP2022/080779

§ 371 Date: May 1, 2024

(30) Foreign Application Priority Data
Nov. 4, 2021 (DE) 102021128715.4

(51) Int. Cl. B23K 26/03; B23K 26/06; B23K 26/244; B23K 101/36

(52) U.S. Cl. CPC B23K 26/032; B23K 26/0626; B23K 26/244; B23K 2101/36

(57) ABSTRACT

A method for laser welding a first and an at least partially overlapping second workpiece sheet along a machining path includes: detecting a distance from a reference to the first and to the second sheet at a plurality of positions; determining a gap width between the sheets based on the distances; and welding together the sheets by radiating the beam along the path and forming a weld seam. The laser beam power is adapted to the respective gap width along the path. A laser machining system for welding sheets using a machining laser beam includes: a distance measuring device detecting a distance to a first and second sheet at a plurality of positions; deflection optics guiding the beam along a machining path; and a control device determining a gap width between the sheets based on the distances. The control device adapts the laser beam power to the respective gap width.

### CROSS-REFERENCE TO RELATED APPLICATIONS

This application is the U.S. National Stage of PCT/EP2022/080779 filed on Nov. 4, 2022, which claims priority to German Patent Application 102021128715.4 filed on Nov. 4, 2021, the entire content of both are incorporated herein by reference in their entirety.

### FIELD OF THE INVENTION

The present invention relates to a method for laser welding with adaptive gap compensation and a laser machining system configured to carry out said method.

### BACKGROUND OF THE INVENTION

In a laser machining system for welding together two workpieces using a laser beam (laser welding), the laser beam emerging from a laser beam source or one end of a laser optical fiber is focused or collimated onto the workpieces to be machined using beam guidance and focusing optics in order to heat them locally to the melting temperature and to create a weld seam. The laser machining system may include a laser machining device, for example a laser welding head.

Depending on the application, high quality requirements are placed on the weld seam. There are fields of application, particularly in the field of electromobility, that require high welding quality. For example, in the field of battery contacting (e.g. cell connectors on cell pole, bus bar welds), the welded connections must have a low electrical resistance while having a high mechanical strength. The same applies to the field of power electronics, for example in the production of aggregates or inverters. Here too, electrical currents flow and the demands on the weld seam in terms of electrical resistance and mechanical strength are high.

When producing a weld seam between two workpieces, in particular two workpiece sheets, the so-called I-seam at the lap joint, a gap between the workpieces may occur. This represents a significant problem when producing high-quality welded joints. In particular, the quality of a weld seam depends heavily on the positioning of the joining partners or workpieces and on the presence of a gap. A gap between two workpieces or joining partners may occur even despite great effort to avoid it. This is particularly the case when clamping devices wear out or become dirty over time during operation or when tolerance chains in the system concept cause gaps. Depending on the size of the gap, the following types of defects may occur: (i) a welding depth that is too small and (ii) a seam volume that is too small to connect the joining partners or missing. The seam volume is also defined using the terms connection area (area in the plane, e.g. the workpiece surface) or connection cross section (area in depth, e.g. perpendicular to the workpiece surface). Welding depth refers to the depth of the weld seam into the lower plate from the surface of the lower plate (see FIG. 1B). Connection area refers to the area or extent of the weld seam at the level of the surface of the lower plate and parallel thereto. An estimate of the seam volume can be made by measuring the weld seam on the surface of the upper plate and the welding depth. The welding depth and the connection cross section have a significant influence on the electrical resistance and mechanical strength of the contact of a component at the weld seam.

If no connection can be established due to the presence of a gap between the joining partners, i.e. the gap is so large that no connection is created during welding, i.e. the gap cannot be bridged, neither electrical current nor mechanical forces can be transmitted. This undesirable condition is referred to as poor welding in the context of seam quality.

If a connection can still be established despite the presence of a gap between the joining partners, i.e. the gap can be bridged, the connection usually still has a reduced seam volume or a reduced connection area compared to a “zero-gap weld”, i.e. a connection without the presence of a gap. This reduced connection area results, for example, in (i) an increase in the electrical resistance combined with an increase in the temperature of the joint and/or in (ii) a reduction in the mechanical strength. Both have an influence on the life span of the welded connection.

The gap may, for example, have a constant or homogeneous, but very often also varying width. A varying gap width means that the gap at one point of the overlap between two workpiece sheets is wider than at another point. Particularly in the field of battery contacting and power electronics, it is not only important to bridge the gap, but also essential to ensure a uniform welding depth. If the welding depth is too high, the temperature in the battery could become too high during welding and the battery could be damaged. In extreme cases, it could also happen that the battery is penetrated during welding. This would be a fatal error and should not occur in production. In many other applications it is also desirable to be able to ensure a constant welding depth with a specified value. The presence of a gap, in particular a gap with varying gap width, makes it difficult to produce a high-quality weld seam.

EP 3 157 706 describes a method for laser power modulation when welding fillet welds on high-strength aluminum alloys.

### SUMMARY OF THE INVENTION

An object of the present invention is to produce a weld seam between two overlapping workpiece sheets that bridges a gap between the workpiece sheets.

A further object is to produce a weld seam between two overlapping workpiece sheets forming a gap, said weld seam having a substantially constant welding depth and/or having a necessary and sufficient welding depth that does not exceed a maximum welding depth.

A further object is to create a weld seam between two overlapping workpiece sheets forming a gap, said weld seam having a sufficiently large seam volume.

Furthermore, it is also an object to produce a weld seam between two overlapping workpiece sheets forming a gap, said weld seam having a substantially homogeneous electrical conductivity and/or sufficient mechanical strength.

Furthermore, another object of the present invention is to produce a high-quality weld between two overlapping workpiece sheets forming a gap.

One or more of these objects are achieved by a method and a laser machining device for laser welding as disclosed herein. Preferred embodiments are disclosed herein.

The invention is based on measuring a gap between first and second workpiece sheets by means of distance measurement, in particular optical distance measurement, for example by means of optical coherence tomography (OCT for short), and adjusting the process parameters, e.g. the laser power of the machining laser beam, to the respective gap width of the gap along the machining path. The gap is preferably measured before welding. With the information from the gap measurement, for example, the laser power of the machining laser beam or, for example, the welding speed can be adaptively adjusted so that (i) the gap is bridged in any case and/or (ii) the connection area of the weld seam or the width of the weld seam is large enough is to meet the requirements for electrical resistance and mechanical strength. The method and the laser machining system may be used, for example, in laser welding of workpiece sheets with scanner optics, with the machining beam being deflected by the scanner optics, which, for example, includes one or two dynamically moving mirrors, and guided to selected positions on the workpiece sheets. In particular, the method and the laser machining system may be used in metal processing, preferably in the machining of components in electromobility, for example in the production and/or machining of batteries and/or battery contacting and/or busbar welding and/or in the production of electronic components, e.g. aggregates or inverters.

According to one aspect, a method for laser welding a first workpiece sheet and a second workpiece sheet that at least partially overlaps the first workpiece sheet along a machining path using a machining laser beam comprises the steps of: detecting a distance, for example from a reference, for example from a laser machining head executing the laser welding method, to the first workpiece sheet and the second workpiece sheet at a plurality of positions and a distance between the first and second workpiece sheets at a plurality of positions, respectively; determining a gap width of a gap between the first workpiece sheet and the second workpiece sheet based on the detected distances and on a thickness of the second workpiece sheet; and welding together the two workpiece sheets by radiating the machining laser beam along the machining path and forming a weld seam; wherein a laser power of the machining laser beam is adjusted to the respective gap width of the gap along the machining path. Since the distance is detected for a plurality of positions on the first workpiece sheet and/or on the second workpiece sheet, a plurality of distances are detected. The gap width may therefore be measured indirectly.

The invention allows for the production of high-quality welded connections despite the presence of a gap, in particular despite a gap with varying gap width, between the first and second workpiece sheets.

A gap often results in a reduced connection area of a weld seam or even no connection area at all, and this may make the component unusable and may signify rejects. This may be reduced or even avoided by the method according to the invention. In the case in which the gap would cause a reduced connection area during normal welding, the method according to the invention can, however, bridge the gap with sufficient connection area or weld seam width and/or welding depth.

The workpiece sheets may be metallic workpieces, in particular metallic workpieces with a substantially flat shape. The first workpiece sheet may also be referred to as the lower sheet and the second workpiece sheet as the upper sheet. In other words, the second workpiece sheet is arranged closer to the laser machining head than the first workpiece sheet, or the second workpiece sheet lies in front of the first workpiece sheet in the laser beam propagation direction. An area where the first workpiece sheet and the second workpiece sheet overlap may be referred to as an overlap area. The space or the distance between the first workpiece sheet and the second workpiece sheet may be referred to as a gap. In particular, the gap may be the distance between the two opposing surfaces of the workpiece sheets, i.e. the distance between the upper surface or surface of the lower sheet and the lower surface or surface of the upper sheet. The distance or the gap width may vary in the overlap area, for example if the (opposing) surfaces of the two workpiece sheets are not arranged in parallel to one another. In this case, the gap nay have a substantially wedge-shaped spatial extent. In other words, the two overlapping workpiece sheets may enclose at least one angle, resulting in a wedge-shaped gap being created between the workpiece sheets. In one embodiment, it is assumed that the two workpiece sheets, at least in the overlap area, have a substantially planar configuration or extent, i.e. may each be defined by two mutually parallel planes of the upper and lower surfaces. The two workpiece sheets, at least partially or at least in the overlap area, may therefore be flat plates.

Detecting or determining a distance to the first and/or the second workpiece sheet at a plurality of positions is carried out in particular with respect to the laser machining head performing the laser welding and/or to a sensor as a reference or with respect to a reference plane or a reference point as a reference. Detecting a distance may also comprise detecting a spatial position of the first workpiece sheet and/or the second workpiece sheet. Alternatively or additionally, detecting a distance may comprise detecting a relative position of the workpiece sheets to one another. For example, detecting a distance may comprise detecting an inclination of the second workpiece sheet relative to the first workpiece sheet. The reference plane may also be the surface of the other workpiece sheet. This may be understood as detecting a distance between a surface of the first workpiece sheet and a surface of the second workpiece sheet, in particular between the opposing surfaces of the workpiece sheets.

According to the present invention, a distance to the first and second workpiece sheets or between the first and second workpiece sheets is detected at at least two positions. Based thereon, the gap width of a gap between the two workpiece sheets can be determined for these at least two positions.

Distances to the first workpiece sheet and the second workpiece sheet or between the first and second workpiece sheets are preferably detected at at least three positions. In particular, three distances on the upper sheet and three distances on the lower sheet may be detected. Since three points or positions span a plane, three positions on the upper sheet may define a position of the upper sheet (in particular a surface of the upper sheet) and three points on the lower sheet may define a position of the lower sheet (in particular a surface of the lower sheet). In total, distances are determined at six positions, i.e. at six points. More distances may also be determined, for example eight, ten, twelve, fourteen or more.

For example, at least three distances between the laser machining head and the upper sheet may be detected at at least three different points or positions on the upper sheet in a peripheral or edge region of the overlap area and/or at least three distances between the laser machining head and the lower sheet may be detected at at least three different points or positions on the lower sheet adjacent to the overlap area. Here, the points on the upper sheet may be chosen in the immediate vicinity of the points on the lower sheet. In other words, a distance may be detected at a point on the upper sheet that is in the overlap area, in particular at an edge of the upper sheet. The distance to the lower plate is then preferably detected at a point immediately adjacent to the overlap area, i.e. a point on the lower plate next to the edge of the upper plate, in particular in the vicinity of one of the points at which the distances to the upper plate are detected. Preferably, for each position on the first workpiece sheet, there is a corresponding position on the second workpiece sheet, which is spaced a maximum of 5 mm from the position on the first workpiece sheet.

Adjusting the laser power of the machining laser beam or the machining laser power may preferably be performed continuously during welding or while traveling along the machining path with the machining laser beam. The machining laser power may therefore preferably be adjusted continuously depending on the gap width at the current welding position on the machining path. In other words, the machining laser power when passing over the workpieces or the upper and lower sheets may be adjusted in real time or at any moment in such a way that the gap between the upper and lower sheets is bridged in such a way that preferably a weld seam with a constant depth is produced. The gap between the upper and lower sheets may be bridged at any point along the machining path during welding. In one embodiment, the laser power is adjusted such that the weld seam has a predetermined and constant welding depth along the machining path.

The gap is preferably measured before welding. With the information from the gap measurement, the machining laser power can be adaptively adjusted such that, on the one hand, the gap is bridged and, on the other hand, the weld seam is wide and/or deep enough to meet specified requirements for the electrical resistance and mechanical strength of the weld seam. The connecting area or the weld seam width can therefore be made sufficiently large in order to achieve good electrical resistance and/or good mechanical strength. In addition, a specified welding depth can be guaranteed regardless of the gap situation.

The laser power of the machining laser beam or machining laser power may be adjusted proportionally to the gap width and/or continuously during welding and/or according to a predetermined function of the gap width along the machining path. The continuous adjustment is preferably carried out according to a continuously differentiable function. The function of the gap width along the machining path can be one- or two-dimensional and expressed by f(x) or f(x,y). Here, x may describe the machining path or welding path. Alternatively, x,y may denote axes of an orthogonal coordinate system.

The continuous adjustment of the machining laser power to the determined gap width along the machining path leads to a particularly precise welding result and ensures high-quality connection or gap bridging at every position on the machining path. In particular, a weld seam with a constant welding depth and/or a sufficient or constant connection area can be produced.

In one embodiment, the machining path may be divided, based on the plurality of positions, into areas in which the laser power of the machining laser beam is set to a predetermined value in accordance with the gap width determined for the respective position. Instead of the machining path, the surface of the second workpiece sheet onto which the machining laser beam is irradiated can also be divided. In other words, the machining path or the surface of the upper sheet, onto which the machining laser beam is radiated, is divided into areas of discrete power values of the machining laser. Here, the average value of the gap width in the respective area can be used to determine the power values. Instead of the average value of the gap width, a maximum value or a lowest value of the gap width in this area may also be used to determine the machining laser power.

The machining laser power may be adjusted approximately in stages or in discrete steps to the gap width at the respective position or in the respective area. The machining laser power may have discrete, equal values in different areas. The division into such areas can be implemented in the form of quadrants, in the form of a grid, in the form of sectors, stripes or other geometric structures. The values of the machining laser power may be taken from a table, for example. In particular, a control device may reference the values in a table and adjust the machining laser power of the machining laser along the machining path.

The division of the machining path or the surface of the upper sheet into areas of discrete values of the machining laser power is particularly uncomplicated and simple and can be easily achieved by reading the values for the machining laser power from a table. For example, a value for the machining laser power may be stored in a table for discrete values of gap widths. This may have the advantage, for example, that no, or at least no complicated, calculation steps are required.

The laser power or machining laser power may preferably be adjusted such that the weld seam along the machining path has a constant or homogeneous welding depth and/or a welding depth greater than a predetermined minimum welding depth and/or a welding depth less than a predetermined maximum welding depth and/or a connecting area or weld seam width greater than a specified minimum connection area or minimum weld seam width.

A weld seam with a constant or homogeneous welding depth along the machining path has the advantage that the quality of the weld seam is constant or homogeneous along the machining path. The minimum value and/or maximum value for the welding depth and/or the connection area may be predetermined, for example for a special application or by the user.

In particular, values for the welding depth and/or connection area may be determined experimentally in advance in order to meet a quality requirement, for example a specified conductivity and/or mechanical strength. For this purpose, test welds may be carried out with different welding depths and/or connection areas, resulting in different qualities. The respective machining laser power and/or the welding depth and/or the connection area may then be assigned to the observed quality feature. A quality feature may be, for example, a value or a range of values for electrical conductivity, resistance and/or mechanical strength. The minimum and/or maximum values of the welding depth and/or connection area may, for example, be specified depending on the application in order to achieve a specific electrical conductivity and/or a specific electrical resistance and/or a specific mechanical strength.

The weld seam may comprise at least one of: a lap I-weld seam, a fillet weld seam, and a line weld seam. Such weld seams are common weld seams that are used in a variety of ways. A fillet weld seam is usually located on the edge of an upper sheet and connects the upper and lower sheets. An overlap I-weld seam is in particular located within the edge of the upper sheet, i.e. not on or at the edge, but completely on the surface of the upper sheet within the overlap area.

Distances are preferably detected at at least three positions on a surface of the first workpiece sheet and on a surface of the second workpiece sheet. From the detected distances to the first and second workpiece sheets or between the first and second workpiece sheets, a spatial position of a surface of the first workpiece sheet and a spatial position of a surface of the second workpiece sheet and/or a relative spatial position of the first and second workpiece sheets with respect to one another and/or a relative inclination of the second workpiece sheet with respect to the first workpiece sheet may be determined.

Three points or positions span a plane. In other words, the position of a planar surface in space can be determined from three points or positions. Therefore, one surface of the first workpiece sheet or the lower sheet may be defined or determined based on three positions. Likewise, a surface of the second workpiece sheet or the upper sheet may be defined or determined based on three positions. In particular, the respective plane of the main surface or the surface of the first workpiece sheet and the second workpiece sheet facing the laser machining head is determined based on three positions. The surface of the first or second workpiece sheet, for which the respective distance is determined, may therefore be referred to as the main surface or the surface facing the laser machining head.

In one embodiment, when determining the gap width of the gap, a three-dimensional gap geometry, in particular a gap geometry within the entire overlap area, is determined. This allows for a value for the machining laser power to be determined for each position along the path or the machining path, in particular in two dimensions. The machining path preferably extends on the surface of the upper sheet.

A gap geometry within the entire overlap area may be interpolated from the determined gap widths at the positions. This allows for the gap width to be determined at each position and the machining laser power to be accordingly reliably adjusted and/or determined.

In particular, the gap width of the gap may be determined based on the detected distances and a predetermined or known thickness of the second workpiece sheet or the upper sheet. The gap width may be determined by subtracting the distance to the upper sheet and the thickness of the upper sheet from the distance to the lower sheet. The gap width is preferably determined taking into account the distances at at least three positions on the main surfaces of the first and second workpiece sheets and taking into account a sheet thickness of the second workpiece sheet.

In particular, the detection of distances may be carried out at a plurality of position pairs, with a position pair comprising a position in an edge region of the overlap area on the second workpiece sheet and a position adjacent thereto on the first workpiece sheet. The positions of the distance measurement on the upper and lower sheets may be chosen to be adjacent to each other. They can be approximately assumed to have been measured at a single point. Alternatively, as explained above, the positions of the surfaces of the upper and lower sheets may be determined and the gap width in the overlap area may be calculated therefrom. In the overlap area, the distance to the lower sheet cannot be determined, at least visually, since the upper sheet covers the lower sheet and is generally opaque. Therefore, the distance to the first workpiece sheet and thus the gap width in the overlap area can typically only be determined by a calculation operation.

The distances are preferably detected using an optical method with a measuring beam, in particular using optical coherence tomography, OCT, an interferometric method, conoscopy, chromatic confocal distance measurement, or laser triangulation.

Particularly preferably, the distance determination may be carried out using optical coherence tomography. For this purpose, an OCT measurement may be carried out, for example, using deflection optics or scanner optics to direct the measuring beam to the plurality of positions. For this purpose, deflection optics is preferably used to guide or deflect the machining laser, for example along the machining path. The deflection optics may comprise at least one movable mirror, preferably two movable mirrors. The deflection optics is preferably configured to deflect the machining laser beam or the measuring beam in at least two mutually perpendicular spatial directions. In this case, the deflection optics may be referred to as a 2D scanner. The deflection optics may also be configured as a 3D scanner. The use of only one deflection optics for the machining laser beam and for determining the distance has the advantage of a particularly compact, simple and efficient configuration of a laser machining device.

Preferably, at least one of the two workpiece sheets is a part of a battery or an electronic component and/or laser welding is carried out for battery contacting or for producing an electronic component, for example an inverter or an aggregate (“power train”).

In a battery, such welds may include, for example, bus-bar welds and/or welds between cell connector and cell pole and/or pin welds. Welds in batteries are subject to particularly high quality standards because they are particularly high-quality components that have a long service life and should function perfectly. The method can therefore achieve particularly advantageous effects in such components.

During welding, the machining laser beam is preferably guided along the machining path by means of deflection optics or scanner optics. In particular, the laser welding of workpiece sheets may be carried out using deflection optics. In other words, welding is carried out my means of the machining laser beam along the machining path by deflecting the machining laser beam using deflection optics.

In particular, the deflection optics carries out the step of deflecting the machining laser beam along the machining path and/or deflecting a measuring beam to detect the distances at the plurality of positions.

Before detecting the distance or distances, the two workpiece sheets may be spatially fixed relative to one another in order to prevent the workpiece sheets from shifting with respect to one another. The distances may then be detected.

According to a further aspect, a laser machining system for laser welding together a first workpiece sheet and a second workpiece sheet along a machining path using a machining laser beam comprises: a distance measuring device for detecting a distance from a reference to the first workpiece sheet and the second workpiece sheet at a plurality of positions; deflection optics or scanner optics for guiding the machining laser beam along the machining path; and a control device for determining a gap width of the gap between the first workpiece sheet and the second workpiece sheet based on the detected distances; wherein the control device is configured to adapt a laser power of the machining laser beam to the respective gap width of the gap along the machining path.

Preferably, the control device is configured to carry out a method according to one of the embodiments described herein.

The laser machining system may include a laser source for providing the machining laser beam. For example, the machining laser beam may be introduced from the laser source into the laser machining head via a laser optical fiber.

The distance measuring device, the control device and/or the deflection optics may be arranged in or on a housing, for example in or on a machining laser head.

The distance measuring device of the laser machining system preferably comprises an optical distance measuring device for detecting the distances using an optical method with a measuring beam, in particular using optical coherence tomography. The laser machining system may be configured such that a beam path of the measuring beam and the machining laser beam extends via the deflection optics. The deflection optics may therefore not only deflect the machining laser beam, but also the measuring beam.

In particular, the distance measuring device may comprise at least one of: an optical coherence tomograph, an interferometric device, a conoscopy device, a chromatic confocal distance measuring device, a laser triangulation device. The deflection optics or scanner optics may comprise at least one of the following elements: a galvo scanner, at least one, preferably two, movable mirrors, and a 2D scanner.

All advantages of the steps of the method according to the aspect or according to a preferred embodiment also apply to the laser machining system with the corresponding features.

The spatially varying gap width is preferably determined completely before welding and thus represents a pre-process step.

The machining path preferably has at least one of the following geometries: a straight or wavy line, a circle, a circular or elliptical or angular spiral or a meander shape.

The weld seam is preferably an overlap I-weld seam, which is created, for example, by completely welding through the first workpiece sheet and partially welding into the second workpiece sheet. The weld seam may also comprise a fillet weld seam if, for example, the machining path extends at least partially along a boundary region between the first and second workpiece sheets.

The gap preferably has a maximum gap width of less than or equal to 10 mm. A gap exists when there is substantially no physical contact at a point between the two workpiece sheets.

A workpiece sheet may comprise a foil, a plate or a small plate. In particular, the sheet thickness is between approximately 20 μm and approximately 2 mm, preferably between approximately 20 μm and approximately 200 μm. Workpiece sheets that have a sheet thickness of approximately 200 μm may in particular be collectors. Workpiece sheets that have a sheet thickness of approximately 20 μm are typically considered to be essentially thin films. Workpiece sheets that have a sheet thickness between approximately 20 μm and 2 mm may in particular be bus bars.

The machining laser beam preferably has a variable, in particular continuously adjustable, machining laser power between approximately 50 W and approximately 5 kW. In particular, for a sheet thickness of the second workpiece sheet of approximately 20 μm, a machining laser power of approximately 50 W is set, and for a sheet thickness of approximately 2 mm, a machining laser power of approximately 5 kW is set. Based on these possible values, the machining laser power is preferably adapted to the spatially varying gap width in order to achieve the most homogeneous welding depth possible.

### BRIEF DESCRIPTION OF THE DRAWINGS

The invention is described in detail below using figures.

FIG. 1A is a schematic plan view of first and second workpiece sheets and shows a spiral machining path and three positions on each of the first and second workpiece sheets at which the distance to the first and second workpiece sheets is detected;

FIG. 1B is a schematic diagram of the welding depth between two workpiece sheets;

FIG. 2 is a schematic side view of the upper sheet and the lower sheet with gap;

FIGS. 3-6 are schematic side views of workpiece sheets with different gap situations and adaptive gap compensation via adapted machining laser power;

FIG. 7 is a flowchart of a method according to embodiments of the invention; and

FIG. 8 is a schematic diagram of a laser machining system for laser welding a first workpiece sheet and a second workpiece sheet using a machining laser beam according to embodiments of the invention.

### DETAILED DESCRIPTION OF THE DRAWINGS

Hereinafter, the same reference symbols designate elements that are the same or have the same effect, and a repetitive and therefore redundant description of these elements has been omitted.

The spatial coordinate z indicated in the figures corresponds to the vertical spatial direction (height direction) and the spatial coordinates x and y each indicate a horizontal spatial direction (longitudinal direction). The laser beam propagation direction may be in the z direction, i.e. an angle of incidence of the machining laser beam on the workpiece surface may substantially be a right angle. A gap S or the gap width 4 of a gap S extends along the z coordinates in the figures and may vary along the x coordinates and/or along the y coordinates. The spatial coordinates were shown arbitrarily and only as examples to better describe the figures.

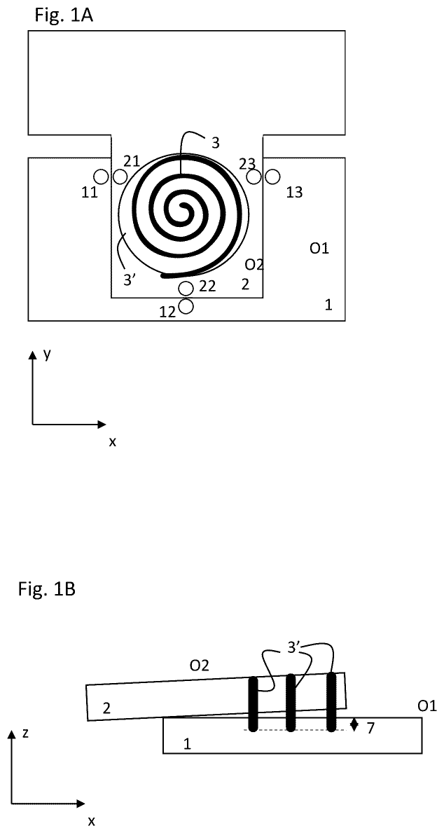

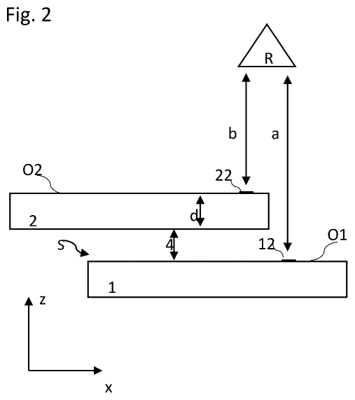

FIG. 1 schematically shows first and second workpiece sheets 1, 2, which are arranged to overlap one another so that they form an overlap area. The workpiece sheet 2 lying above in the z direction or in the laser beam propagation direction may also be referred to as the upper sheet. Accordingly, the workpiece sheet 1 lying below may be referred to as a lower sheet. A gap S may occur when arranging the two workpiece sheets 1, 2. Depending on the relative position of the two workpiece sheets 1, 2, a gap width 4 of the gap S may have different values at different positions in the overlap area (see FIG. 1B). If the gap width 4 varies along at least one of the horizontal spatial directions x and y, i.e. generally increases or decreases, the gap typically has a wedge-shaped extent in the overlap area of the upper sheet 2 and the lower sheet 1. This wedge-shaped extent is the result of a tilting of the two workpiece sheets 1, 2 against each other. A tilting of the upper sheet 2 against the lower sheet 1 may also be understood as a tilting of the lower sheet 1 (first workpiece sheet) against the upper sheet 2 (second workpiece sheet). A tilting of the workpiece sheets is always a relative tilting of the workpiece sheets 1, 2 relative to one another.

The second workpiece sheet 2 and the first workpiece sheet 1 are arranged to form an overlap I-seam in FIG. 1. Welding is to be carried out along a spiral-shaped machining path 3. The spiral-shaped machining path 3 is in particular a predetermined path that is traversed by a machining laser beam. The spiral-shaped machining path 3 lies on the surface O2 of the second workpiece sheet 2 which overlaps the first workpiece sheet 1. In other words, the machining laser beam 5 is moved in an overlap area of the first and second workpiece sheets 1, 2 in order to weld together the two workpieces 1, 2 and form a weld seam.

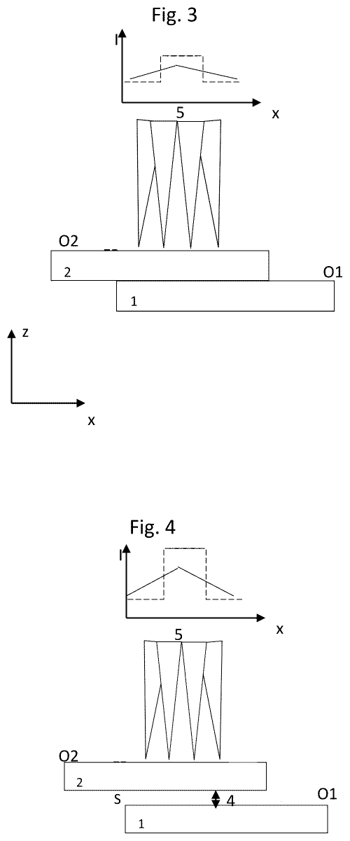

There is therefore a gap S between the workpiece sheets 1, 2 (see FIG. 2). The gap width 4 is not necessarily constant, for example when the upper plate 2 is tilted relative to the lower plate 1. The gap S is to be bridged during welding in order to create a sufficiently large connection area and thus achieve low electrical resistance and high mechanical strength. At the same time, the welding depth 7 (see FIG. 1B), i.e. from the top of the lower plate 2 to the end of the weld seam 3′, is to be kept as constant or homogeneous as possible, for example to avoid that temperature limit values on a battery pole are exceeded or welding penetrates the battery. A homogeneous welding depth 7 has a constant depth along the machining path 3. An example of a homogeneous welding depth is indicated in FIG. 1B. The two workpiece sheets 1, 2 are tilted against each other. In the example of FIG. 1B, the welding depth 7 is the depth that the weld seam 3′ has with respect to the surface O1 of the lower sheet 1. In order to obtain a constant welding depth, the machining laser power is adapted to the gap width 4 at the respective welding position along the machining path. For this purpose, for example, as indicated in FIG. 1A, a distance a, b between a reference R and the first and second workpiece sheets 1, 2 is first detected at six positions 11, 12, 13, 21, 22, 23. However, the present disclosure is not limited thereto. The six positions 11, 12, 13, 21, 22, 23 may be understood as three pairs of positions on the upper and lower plates 1, 2. The positions of a pair preferably include a first position on the first workpiece sheet 1 and a second position on the second workpiece sheet 2, which lie next to one another or are adjacent.

In a first step, the gap S or the gap width 4 is determined indirectly by detecting distances a, b between a reference R, such as the laser machining head or optics, and the surfaces O1, O2 of the workpiece sheets 1, 2 at positions 11 and 21 (in the z direction, i.e. out of the image plane of FIG. 1, see FIG. 2). The gap width 4 may be determined from the difference between the distances a, b and after subtracting the thickness d of the second workpiece sheet. The surface O2 represents a main surface of the second workpiece 2 which faces the machining laser beam 5 and in particular a distance measuring device 101 or onto which the machining laser beam 5 is radiated. Likewise, the surface O1 represents a main surface of the first workpiece 1 which faces the machining laser beam 5 and in particular a distance measuring device 101. This procedure is repeated for a plurality of position pairs 12, 22 and 13, 23. In this example, this results in information about three gap widths 4, i.e. the gap width 4 at three positions, and thus the tilting of the second workpiece sheet 2 with respect to the first workpiece sheet 1 can be determined.

In a second step, this information is used to adjust the machining laser power I. If there is a gap S or if one of the workpiece sheets 1, 2 is tilted, the machining laser power I is increased or adjusted depending on the gap width 4 or the tilting.

The second workpiece sheet 2 has a T-shape in FIG. 1 and may be a battery contact element, for example a cell connector. A T-shape has a web and a base. The spiral-shaped machining path 3 is indicated on the web in FIG. 1. The web may, for example, have a width of approximately 8 mm. The web is narrower than the base. The first workpiece sheet 1 may be a cell pole of a battery. In FIGS. 1 and 2, the distance a, b between a reference R and the first and second workpiece sheets 1, 2 is detected by means of an optical method, in particular by means of optical coherence tomography, at three position pairs 11, 21, 12, 22, 13, 23. The distance a, b is therefore detected in pairs of positions, namely at position 11 on the first workpiece sheet 1 and position 21 on the second workpiece sheet 2, at position 12 on the first workpiece sheet 1 and position 22 on the second workpiece sheet 2, and at position 13 on the first workpiece sheet 1 and position 23 on the second workpiece sheet 2. The pairings of these positions are characterized by the local proximity of the position pairs. This proximity or distance between two centers of the respective positions or measuring positions may be, for example, between approximately 3 cm and 0.1 mm, in particular approximately between 1 cm and 0.15 mm and preferably approximately between 0.5 mm and 0.2 mm. The reference may be defined by the distance measuring device 101 or an element of the distance measuring device. For example, by a reference plane of an optical sensor.

The positions 21, 22, 23, at which the distances b to the second workpiece sheet 2 are detected, are preferably located on the surface O2 of the second workpiece sheet 2 on an edge thereof and thus on an edge of the overlap area of the two workpiece sheets 1, 2. The positions 11, 12, 13, at which the distances a to the first workpiece sheet 1 are detected, are each on the surface O1 of the first workpiece sheet 1 near the edge of the overlap area of the two workpiece sheets 1, 2.

Based on the three pairs of positions or the six positions 11, 12, 13, 21, 22, 23, respectively, the respective spatial positions of the planar workpiece sheets 1, 2 may be determined. In particular, the spatial positions of the respective surfaces O1, O2 are determined. For example, the respective distances a, b at these positions 11, 12, 13, 21, 22, 23 may be transmitted to a computing or control device, which in turn determines or calculates how the gap width 4 of a gap S proceeds or extends in the overlap area.

The gap width 4 of the gap S may, for example, be substantially wedge-shaped. In this case, it is difficult to ensure a sufficient welding depth 7 at every point on the machining path 3.

In order to be able to bridge the gap S regardless of the gap shape, a laser power I of the machining laser beam 5 is adapted to the respective gap width 4 of the gap S when welding together the two workpiece sheets 1, 2 by radiating the machining laser beam 5 along the machining path 3 and when forming a weld seam 3′. This means that, for example, with a gap S that has a continuously increasing gap width 4 along the x-axis, the machining laser power I is also increased. This increase in the power I or machining laser power may in particular occur continuously and in particular follow a continuously differentiable function. This may be the case, for example, in FIG. 1, wherein the machining laser power I is continuously adjusted along the spiral machining path 3.

If the gap S shows no change in the gap width 4, the machining laser power I may also be kept constant at a value that is suitable for forming a weld seam 3′ with the desired quality and/or the desired properties. Alternatively, the machining laser power I may be changed slightly along the x and/or y coordinates even in this example without a gap S.

In FIG. 1, the weld seam 3′ which results from the spiral-shaped machining path 3 may be substantially circular, dot-like and/or dome-like. The weld seam 3′ may, for example, be a substantially circular weld seam 3′ which has a diameter of approximately 5 mm.

FIG. 2 is a schematic sectional view of the arrangement of FIG. 1 in the x-z plane. The distance a between a reference R and the surface O1 of the first workpiece sheet 1 is detected at position 12 and the distance b between the reference R and the surface O2 of the second workpiece sheet 2 is detected at position 22. The gap width 4 of the gap S can then be determined at least approximately. For example, the gap width 4 in the immediate vicinity of the measuring positions 12, 22 can be at least approximately calculated using the following equation:

Gap width 4=distance a−distance b−thickness of upper sheet 2

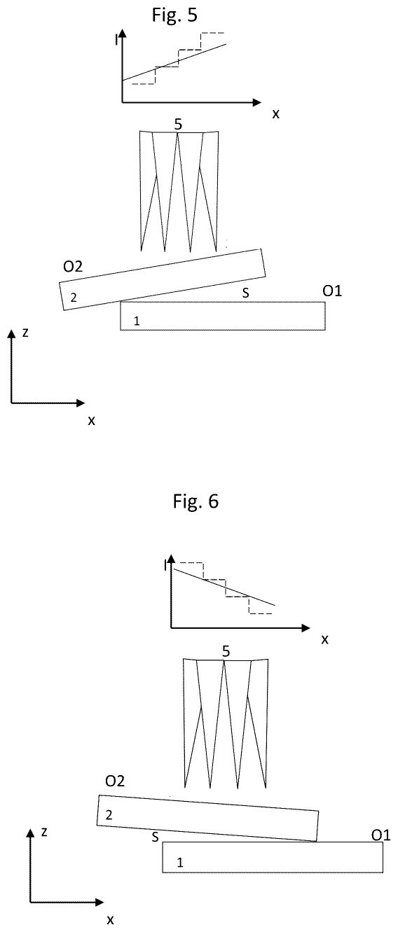

FIGS. 3-6 are schematic diagrams of workpiece sheets 1, 2 with different gap situations and adaptive gap compensation via adapted machining laser power I. In FIGS. 3-6, a machining laser beam 5 is shown at a plurality of positions along the machining path (here along the spatial coordinate x) on the upper sheet 2. The surfaces O1, O2 of the lower and upper sheets 1, 2 substantially face the machining laser beams 5 and the measuring beams 6. The machining laser power I is plotted against the spatial coordinate x or against the variable of the machining path in a diagram at the top of FIGS. 3-6.

FIG. 3 shows an arrangement of a first workpiece sheet 1 and a second workpiece sheet 2 where there is no gap S (zero-gap situation). The machining laser beam 5, which extends or is scanned along the machining path 3, is indicated by a plurality of beams. Since there is no gap S, the power I of the machining laser beam 5 in FIG. 3 may be kept constant along the spatial coordinates x. However, the power I of the machining laser beam 5, as indicated in FIG. 3, may be changed gradually or continuously in order to set a lower machining laser power I at the edge of the overlap area than in the middle of the overlap area. Without a gap S, laser welding is essentially complication-free, and therefore no gap S needs to be compensated for.

FIG. 4 shows an arrangement of a first workpiece sheet 1 and a second workpiece sheet 2 where a homogeneous gap S is present. Since there is a homogeneous gap S, the power I of the machining laser beam 5 is preferably adjusted along the machining path, as indicated in the diagram. In particular, the power I of the machining laser beam 5 may be increased compared to a zero-gap situation. In addition, the power I of the machining laser beam 5, as indicated in FIG. 4, may be changed gradually or continuously in order to set a lower machining laser power I at the edge of the overlap area than in the middle of the overlap area. For example, a higher machining laser power I may be set in the center of a spiral-shaped machining path 3 than in the outer region of the spiral.

FIG. 5 shows an arrangement of a first workpiece sheet 1 and a second workpiece sheet 2 where a gap S with varying (i.e. location- or position-dependent) gap width 4 is present. In other words, the upper sheet, i.e. the second workpiece sheet 2, is tilted relative to the lower sheet, i.e. the first workpiece sheet 1. The gap width 4 increases in the x direction in FIG. 5. The gap width 4 increases linearly, which is due to the planar configuration of the workpiece sheets 1, 2. As indicated in FIG. 5, the machining laser power I is adjusted such that it increases as the gap width increases. For example, the machining laser power I may be adjusted linearly or discretely, i.e. stepwise. The machining laser power I may therefore be increased when traveling along a machining path 3 in the x direction in order to compensate for the gap S that increases as the x values increase.

FIG. 6 shows an arrangement of a first workpiece sheet 1 and a second workpiece sheet 2 where there is also a gap S with varying (i.e. location- or position-dependent) gap width 4. In this case too, the upper sheet, i.e. the second workpiece sheet 2, is tilted relative to the lower sheet, i.e. the first workpiece sheet 1. However, the gap width 4 decreases in the x direction in FIG. 6. The gap width 4 decreases linearly, which is due to the planar configuration of the workpiece sheets 1, 2. As indicated in FIG. 6, the machining laser power I is adjusted such that it decreases as the gap width decreases. For example, the machining laser power I may be adjusted linearly or discretely, i.e. stepwise. The machining laser power I may therefore be reduced when traveling along a machining path 3 in the x direction in order to compensate for the gap S decreasing as the x values increase.

This means that the gap S may be reliably bridged even if the workpiece sheets 1, 2 are tilted relative to one another. In particular, a constant welding depth 7 of the weld seam 3′ can be achieved.

As an alternative to a linear, continuous increase in the machining laser power I along the x direction, the profile of the machining laser power I may also follow another function. In particular, the machining laser power I may follow a continuously differentiable function. The function may also not be linear under certain circumstances. The machining laser power I may also follow a step-shaped function, for example when the overlap area is divided into sectors in which the machining laser power I has discrete values.

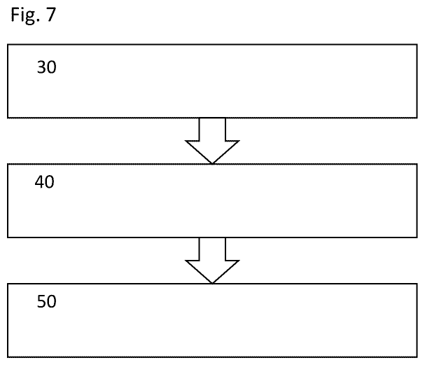

FIG. 7 is a flowchart of the method steps that may be used to implement the invention. The method for laser welding a first workpiece sheet 1 and a second workpiece sheet 2 that at least partially overlaps the first workpiece sheet 1 along a machining path 3 by means of a machining laser beam 5 comprises the steps of: detecting 30 a distance a, b from a reference R to the first workpiece sheet 1 and to the second workpiece sheet 2 at a plurality of positions 11, 21, 12, 22, 13, 23. This is followed by determining 40 a gap width 4 of a gap S between the first workpiece sheet 1 and the second workpiece sheet 2 based on the detected distances a, b. This is followed by welding 50 together the two workpiece sheets 1, 2 by radiating the machining laser beam 5 along the machining path 3 and forming a weld seam 3′. For this, a laser power I of the machining laser beam 5 is adapted to the respective gap width 4 of the gap S along the machining path 3.

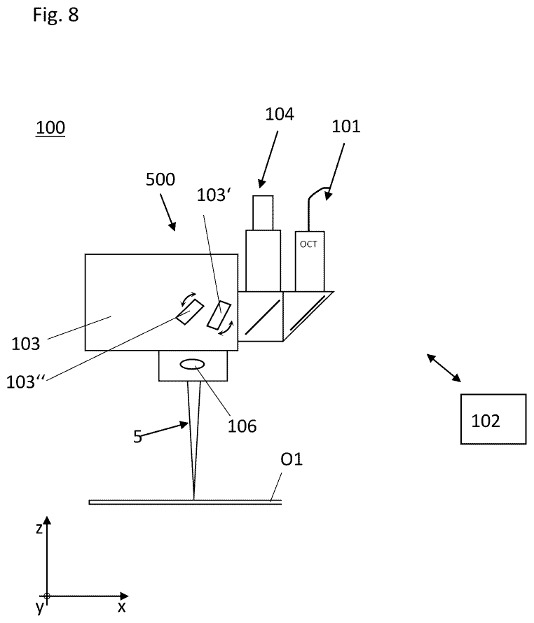

FIG. 8 shows a laser machining system 100 including a laser machining head 500 for laser welding a first workpiece sheet 1 and a second workpiece sheet 2 by means of a machining laser beam 5. The laser machining system 100 includes a distance measuring device 101 configured to detect a distance a, b to the first workpiece sheet 1 and to the second workpiece sheet 2 at a plurality of positions 11, 21, 12, 22, 13, 23. The laser machining system 100 also includes a control device 102 configured to determine a gap width 4 of the gap S between the first workpiece sheet 1 and the second workpiece sheet 2 based on the detected distances a, b. In addition, the laser machining system 100 also includes deflection optics 103 for guiding the machining laser beam 5 along a machining path 3. The control device 102 is configured to adapt the laser power I of the machining laser beam 5 to the respective gap width 4 of the gap S along the machining path 3. The control device 102 and the distance measuring device 101 may communicate with each other wirelessly or by wire.

In FIG. 8, the laser machining system 100 also includes a fiber coupler 104 allowing for the machining laser beam 5 from a laser source (not shown) to be coupled into the laser machining head 500. The laser machining system 100 may include the laser source for generating the machining laser beam 5.

In FIG. 8, the distance measuring device 101 comprises an optical distance measuring device for detecting the distances a, b by means of an optical method with a measuring beam 6, in particular by means of optical coherence tomography. In particular, the laser machining system 100 is configured such that the measuring beam 6 passes the deflection optics 103 for guiding the machining laser beam 5 and the focusing optics 106 for focusing the machining laser beam 5. Thus, both the machining laser beam 5 and the measuring beam 6 may be directed or deflected to different positions by means of the deflection optics 103. The deflection optics 103 may, for example, include two pivotable mirrors 103′, 103″.

In particular, an OCT sensor may serve as the distance measuring device 101 in order to determine distances a, b using optical coherence tomography. From the distances a, b, it is possible to draw conclusions about the gap situation or the tilting of the workpiece sheets 1, 2 relative to one another.

The distance measuring device 101, in particular a sensor of the distance measuring device 101 which can detect distances a, b, may be integrated, for example, in the machining laser head 500 of the laser machining system 100. Alternatively, a sensor may also represent a “stand-alone” component, i.e. a component that is distant and/or separate from the welding head.

In summary, according to the present invention, the gap situation is detected by distance measurements. In this way, the tilting between upper sheet 2 and lower sheet 1 may be determined. Based on this information, the machining laser power I is adjusted such that the following quality criteria of the weld seam can be met: The gap S should be bridged. Furthermore, the welding depth 7 should not be too small, i.e. absolutely and/or in relation to one of the measuring points of the upper sheet. Furthermore, the connecting area should be sufficiently large, in particular with regard to electrical resistance and/or mechanical strength. Furthermore, the welding depth 7 should not be too great in view of the maximum permissible temperature at a battery pole and/or in view of the risk of welding into the battery. To meet these quality criteria, laser power modulation is carried out during welding in order to adaptively compensate for the gap S.

Therefore, a method according to the invention or a laser machining system according to the invention can ensure that a gap S between two joining partners is bridged during welding at every point along the machining path 3 and a weld seam 3′ with a predetermined and constant welding depth 7 or with a predetermined width or connection area is produced.

### LIST OF REFERENCE SYMBOLS

1 first workpiece sheet or lower sheet
2 second workpiece sheet or upper sheet
3 machining path
3′ weld seam
4 gap width
machining laser beam
6 measuring beam
7 welding depth
11 first position for detecting a distance between a reference and the surface of the first workpiece sheet or lower sheet
12 second position for detecting a distance between a reference and the surface of the first workpiece sheet or lower sheet
13 third position for detecting a distance between a reference and the surface of the first workpiece sheet or lower sheet
21 first position for detecting a distance between a reference and the surface of the second workpiece sheet or lower sheet
22 second position for detecting a distance between a reference and the surface of the second workpiece sheet or lower sheet
23 third position for detecting a distance between a reference and the surface of the second workpiece sheet or lower sheet
30 process step “detecting a distance”
40 process step “determining a gap width”
50 process step “welding the workpieces”
100 laser machining system
101 distance measuring device
102 control device
103 deflection optics
103′, 103″ mirror
104 fiber coupler
106 focusing optics
500 laser machining head
a distance from a reference to the first workpiece sheet
b distance from a reference to the second workpiece sheet
d thickness of the second workpiece sheet or the upper sheet
I power of the machining laser or machining laser power
O1 surface of the first workpiece sheet or the lower sheet
O2 surface of the second workpiece sheet or the upper sheet
R reference
S gap
x spatial coordinate
y spatial coordinate
z spatial coordinate

1. A method for laser welding a first workpiece sheet and a second workpiece sheet at least partially overlapping said first workpiece sheet along a machining path by means of a machining laser beam, comprising the steps of:
detecting a distance at a plurality of positions on said first workpiece sheet and on said second workpiece sheet;
determining a gap width of a gap between said first workpiece sheet and said second workpiece sheet based on the detected distances and a predetermined thickness of said second workpiece sheet; and
welding together the two workpiece sheets by radiating said machining laser beam along said machining path and forming a weld seam;
wherein a laser power of said machining laser beam is adapted to the respective gap width of said gap along said machining path.

2. The method according to claim 1, wherein the laser power of said machining laser beam is adapted in proportion to the gap width and/or continuously during welding and/or according to a predetermined function of the gap width along said machining path.

3. The method according to claim 1, wherein the machining path is divided, based on the plurality of positions, into areas in which the laser power of said machining laser beam is set to a predetermined value according to the gap width determined for the respective position.

4. The method according to claim 1, wherein the laser power of said machining laser beam is adapted such that said weld seam along said machining path has a constant welding depth and/or a welding depth greater than a predetermined minimum welding depth and/or a welding depth less than a predetermined maximum welding depth and/or a connection area greater than a predetermined minimum connection area.

5. The method according to claim 1, wherein detecting the distances comprises: detecting distances at at least three positions on a surface of said first workpiece sheet and on a surface of said second workpiece sheet.

6. The method according to claim 1, wherein, from the detected distances to the first and second workpiece sheet, a relative position of said second workpiece sheet with respect to said first workpiece sheet and/or a spatial position a surface of said first workpiece sheet and a spatial position of a surface of said second workpiece sheet are determined.

7. The method according to claim 1, wherein a three-dimensional gap geometry is determined when determining the gap width of said gap.

8. The method according to claim 1, wherein said weld seam is an I-seam on the lap joint.

9. The method according to claim 1, wherein the distances are detected by means of an optical method with a measuring beam, said optical method in particular comprising at least one of: optical coherence tomography, an interferometric method, conoscopy, chromatic confocal distance measurement, and laser triangulation.

10. The method according to claim 1, wherein at least one of the two workpiece sheets is part of a battery or an electronic component, and/or wherein the laser welding is carried out for battery contacting or for producing an electronic component.

11. The method according to claim 1, wherein said machining laser beam is guided along said machining path by deflection optics during welding.

12. A laser machining system for laser welding a first workpiece sheet and a second workpiece sheet by means of a machining laser beam, comprising:
a distance measuring device for detecting a distance at a plurality of positions on said first workpiece sheet and on said second workpiece sheet;
deflection optics for guiding said machining laser beam along a machining path; and
a control device for determining a gap width of said gap between said first workpiece sheet and said second workpiece sheet based on the detected distances;
wherein said control device is configured to adapt a laser power of said machining laser beam to the respective gap width of said gap along said machining path.

13. The laser machining system according to claim 12, wherein said distance measuring device comprises an optical distance measuring device for detecting the distances by means of an optical method with a measuring beam, in particular by means of optical coherence tomography, and
wherein said deflection optics is arranged and configured to direct said measuring beam to the plurality of positions.
